(19) United States
(12) Patent Application Publication
(10) Pub. No.: US 2024/0287686 A1
(43) Pub. Date: Aug. 29, 2024

(54) AQUEOUS REACTOR

(71) Applicant: Advanced Combustion Technologies, Inc., Las Vegas, NE (US)

(72) Inventors: Robert Plaisted, Santa Clarita, CA (US); Chaslav Radovich, San Clemente, CA (US)

(73) Assignee: Advanced Combustion Technologies, Inc., Las Vegas, NE (US)

(21) Appl. No.: 18/431,923

(22) Filed: Feb. 2, 2024

Related U.S. Application Data
(60) Provisional application No. 63/448,194, filed on Feb. 24, 2023.

(51) Int. Cl. C25B 1/04; C25B 9/63; C25B 9/65; C25B 11/031; C25B 11/046

(52) U.S. Cl. CPC C25B 1/04; C25B 9/63; C25B 9/65; C25B 11/031; C25B 11/046

(57) ABSTRACT

A hydrogen generating cell comprising an input electrode plate pair, an output electrode plate pair, an X plate electrode positioned adjacent the output electrode plate pair, and a plurality of intermediate electrode plates disposed between the input and output electrode plate pairs. A plasma torch is spaced apart from and inductively coupled to the input electrode plate pair. A pulsed DC voltage is applied to the plasma torch and X-plate, while a lower voltage pulsed DC is applied to the input and output electrode plate pair to cause generation of hydrogen gas from water in which the cell is immersed.

### CROSS REFERENCE TO RELATED APPLICATION

This application claims the benefit of and priority to U.S. Provisional Patent Application Ser. No. 63,448,194 filed Feb. 24, 2023, and entitled “Aqueous Reactor,” the contents of which is hereby incorporated by reference herein in its entirety.

### FIELD OF THE DISCLOSURE

The subject disclosure relates to methods and apparatus for generating hydrogen gas from an aqueous solution.

### DESCRIPTION OF RELATED ART

Apparatus for generating hydrogen gas from an aqueous solution has been proposed in the past.

### SUMMARY

According to illustrative embodiments, a tank containing a liquid comprising water and an electrolyte is provided. A hydrogen generating cell is immersed in the liquid in the tank, the cell comprising an input electrode plate pair, an output electrode plate pair, an additional “X” plate electrode positioned adjacent the output electrode plate pair, and a plurality of intermediate electrode plates disposed between the input and output electrode plate pairs. A plasma torch is spaced apart from and inductively coupled to the input electrode plate pair.

Drive circuitry for the electrodes is further provided comprising an AC power source, a transformer is connected to the AC power source, and a first three-phase rectifier coupled to the transformer. A second three-phase rectifier is also coupled to the AC power source. The second three-phase rectifier is configured to apply a pulsed DC voltage to the plasma torch and X-plate electrode, while the transformer and first three-phase rectifier are configured to apply a lower pulsed DC voltage to the input and output electrode plate pair, resulting in hydrogen gas generation.

According to another embodiment, a hydrogen generating cell comprises an input electrode plate pair, an output electrode plate pair, an additional electrode plate positioned adjacent the output electrode plate pair, and a plurality of intermediate electrode plates disposed between the input and output electrode plate pairs. A plasma torch is spaced apart from and inductively coupled to the input electrode plate pair.

In various illustrative embodiments, the additional electrode plate may have a rectangular frame within which is formed an “X” shaped cross member and wherein respective triangular areas between the frame and cross member are hollow and water transmissive. In illustrative embodiments, such structure facilitates low current operation. The additional electrode plate may be structured differently in other embodiments. Various illustrative embodiments may also employ a plasma torch which is a TIG plasma torch.

The disclosure further contemplates a hydrogen gas generating apparatus which comprises a plurality of serially arranged electrode plates together with a plasma torch spaced apart from and inductively couple to at least a first of the electrode plates. In one such embodiment, the plurality of electrode plates may comprise an input electrode plate pair, an output electrode plate pair, and a plurality of intermediate electrode plates disposed between the input and output electrode plate pairs.

An additional electrode plate may be included in various embodiments which is spaced apart from an output electrode plate pair on a side of the output plate electrode plate pair which is opposite a side of the output electrode plate pair which faces a set or plurality of intermediate electrode plates. In such embodiments, the additional electrode may comprise a rectangular frame within which is formed an “X” shaped cross member and wherein respective triangular areas between the frame and cross member are hollow and water transmissive but may be differently structured in various embodiments.

According to another aspect of the disclosure, a method of constructing an apparatus for generating hydrogen is provided comprising stacking a plurality of electrode plates serially adjacent and spaced apart from one another and positioning a plasma torch spaced apart from a first of said electrode plates so as to be inductively coupled to the first plate. Various embodiments of such a method may further include configuring the plurality of electrodes to comprise an input electrode plate pair, an output electrode plate pair, and a plurality of intermediate electrode plates disposed between the input and output electrode plate pairs.

Various embodiments may further include constructing an additional electrode plate and positioning the additional electrode plate adjacent and spaced apart from an output electrode plate pair. Such embodiments may further include constructing the additional electrode plate to comprise a rectangular frame within which is formed and “X” shaped cross member and wherein triangular areas between the frame and cross member are hollow and water transmissive.

Another aspect of the disclosure provides circuitry for supplying power to a hydrogen generating aqueous reactor comprising a transformer configured to be connected to an AC power source and a first three-phase rectifier coupled to an output of the transformer. A second three-phase rectifier is further configured to connect to the AC power source. In such an embodiment, the second three-phase rectifier may be configured to generate a first voltage of a first magnitude, while the transformer and first three-phase rectifier may be configured to generate a second voltage of a second magnitude less than said first magnitude.

### DESCRIPTION OF THE DRAWINGS

FIG. 1 is a side view schematic diagram of an illustrative embodiment of a hydrogen producing aqueous reactor;

FIG. 2 is an electrical circuit diagram of circuitry for powering the reactor of FIG. 1;

FIG. 3 is a schematic diagram illustrating an interleaving plate structure according to an illustrative embodiment;

FIG. 4 is a perspective view of an electrode plate according to an illustrative embodiment;

FIG. 5 is a perspective view of three plates of FIG. 4 in an interconnected relationship;

FIG. 6 is front view of two electrode plates in an interconnected relationship;

FIG. 7 is a front view of an X plate according to an illustrative embodiment;

FIG. 8 us a waveform diagram of an illustrative voltage output of a first three phase rectifier;

FIG. 9 is an electrical circuit diagram illustrating an alternate transformer structure according to an illustrative embodiment; and

FIG. 10 is a waveform diagram of an illustrative voltage output of a second three phase rectifier,

### DETAILED DESCRIPTION

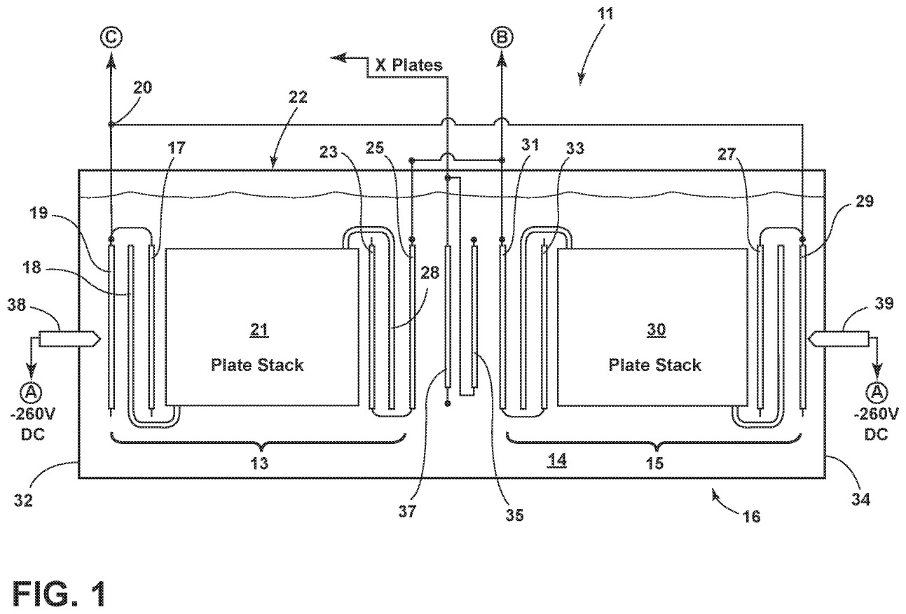

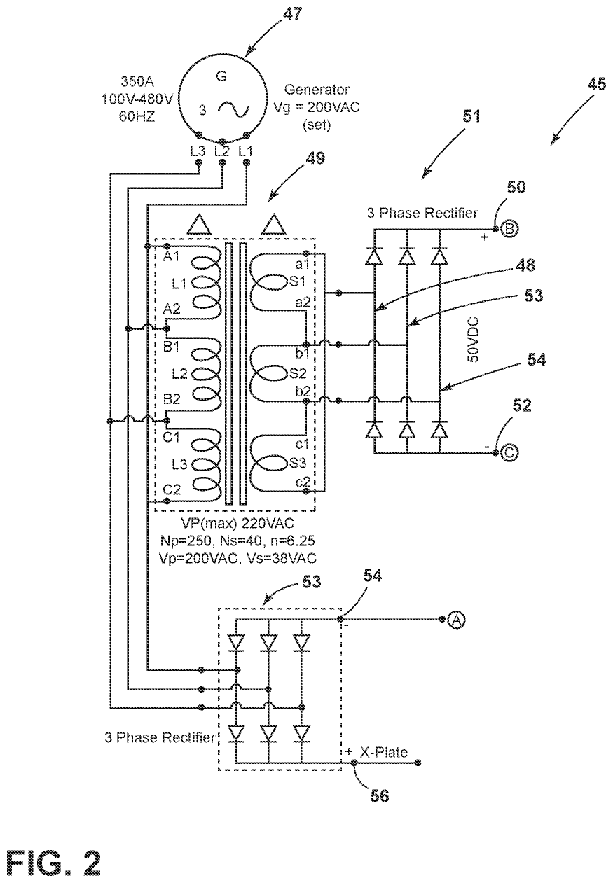

An illustrative embodiment of an aqueous reactor 11 is illustrated in FIG. 1, and circuitry for powering the reactor 11 is illustrated in FIG. 2. As shown, the circuitry of FIG. 2 comprises an input AC power source 47, a transformer 49, and first and second three phase rectifiers 51, 53. The output voltage of the first three phase rectifier, nominally at 50 volts DC, appears across a positive output terminal labeled “B” and a negative output terminal labeled “C.” The output voltage of the second three phase rectifier 53 appears across a negative output terminal labeled “A” and a positive output terminal 56.

The transformer 49 includes three primary windings L1, L2, L3, which transfer power to respective secondary windings S1, S2, S3. These secondary windings in turn are connected to junction points between the cathodes and anodes of respective diode pairs 48, 53, 54 of the three-phase rectifier 51.

The aqueous reactor 11 shown in FIG. 1 includes two horizontal arrays 13, 15 of parallel electrically conductive electrode plates immersed in a liquid bath 14 contained in a vessel or tank 16. The first plate array 13 includes a pair of series connected input plates 17, 19, a plate stack 21, and first and second output plates 23, 25, also connected in series. The second plate array 15 includes a pair of series connected input plates 27, 29, a plate stack 30, and first and second output plates 31, 33, also connected in series. First and second “X” plates 35, 37 are positioned between the outermost output plates 25 and 31. In an illustrative embodiment, the tank 16 may have rectangular sidewalls and rectangular end walls 32, 34 and a closed and sealed top 22.

In the illustrative embodiment, the negative voltage at terminal A of the three-phase rectifier 53 is inductively coupled to the input plate pairs 19, 17 and 27, 29 by respective tungsten plasma torches 38, 39. In the illustrative embodiment, these torches 38, 39 are sealably mounted to and extend through the end walls 32, 34 of the vessel 16. In an illustrative embodiment, the torches 38, 39 may be 150 amp rated TIG plasma torches.

In an illustrative embodiment, the tip of each torch 38, 39 may be positioned 1 and ¼ inches from its respective input plate 19, 29 but may be positioned at other distances in other embodiments. In FIG. 1, the torches 38, 39 are shown extending through a watertight seal in the respective end walls 32, 34 of the vessel 16 and into the liquid bath 14. In other embodiments, such torches could be positioned entirely within the vessel 16 and liquid bath 14.

As further shown in FIG. 1, the top of the X-Plate 37 and the bottom of the X-Plate 35 are respectively electrically connected to the positive voltage terminal 56 of the second three-phase rectifier 53. The input plate pairs 17, 19; 27, 29 are connected to the negative output terminal “C” of the first three-phase rectifier 51, while the output terminal pairs 23, 25; 31, 33 are connected to the positive output terminal “B” of that rectifier 51.

In an illustrative embodiment, the liquid bath 14 may comprise an aqueous solution comprising 1% potassium hydroxide (KOH) to increase conductivity to allow electron flow while maintaining a high impedance, eg One Mega Ohm per inch. Electrolytes other than potassium hydroxide may be used in other embodiments.

In one embodiment, the tank 16 may contain 75 gallons of water under a pressure of six inches of mercury. The system can also operate at atmospheric pressures. In one embodiment, a vacuum pump is used to apply the pressure and also serves to draw the generated hydrogen gas out of the tank 16. The electrical leads to the first and second three-phase rectifiers 51, 53 may pass through the top 22 of the tank 16 and are sealed to the top 16 to maintain the vacuum and watertightness.

The AC power source 47 shown in FIG. 2 may comprise, for example, a gasoline, diesel, or solar powered generator providing a 350-amp, 200-volt, 60 Hz output signal. Power from the source 47 is supplied to the transformer 47, whose secondary, as described above, is connected to the first three-phase rectifier 51, which in one embodiment may be an MD 5500 A 1600V. The second three-phase rectifier 53 may also be an MD 5500 A 1600V and functions to generate a 260-volt pulsed DC waveform across its terminals 54, 56. In the illustrative embodiment, the first three-phase rectifier 51 functions to produce a 50-volt pulsed DC waveform.

In an illustrative embodiment, the negative terminal (torch) waveform and the positive terminal (X-plate) waveform each have a 60 per cent duty cycle but are 180 degrees out of phase with each other. Each wave form is at a frequency of 180 Hz such that one hundred eighty 60 per cent duty cycle pulses are generated each second. Other duty cycles may be employed in other embodiments.

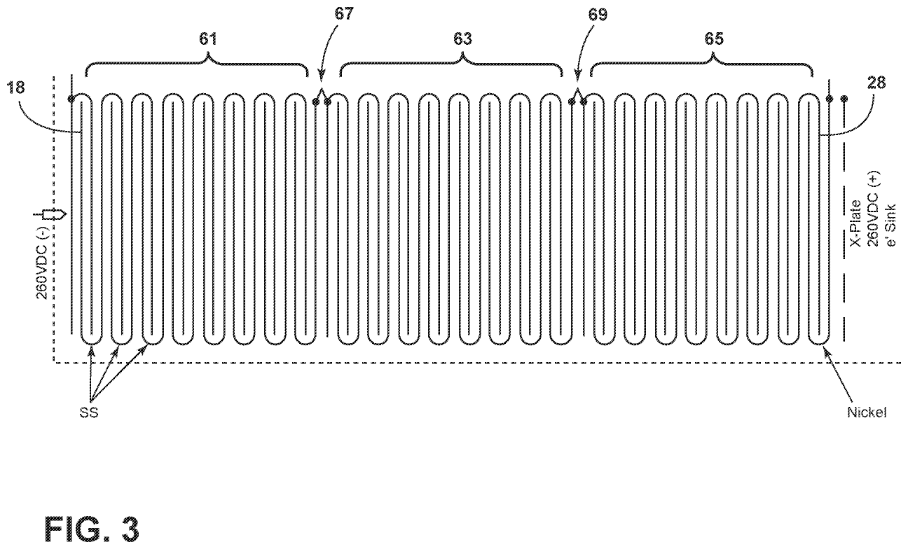

In one illustrative embodiment, as shown in FIG. 3, the arrays 13, 15 of parallel electrode plates shown in FIG. 1 may each comprise seventy-five horizontally positioned adjacent parallel plates, each of which may comprise three groups 61, 63, 65 of 25 plates each. In the illustrative embodiment, the plates of the groups other than the end plate pairs 17. 19; 23, 25 are formed as groups of three electrically connected plates interleaved with adjacent three plate groups. Other than the end plate pairs, the plates of all of the groups are electrically isolated from one another except for electrical connections 67, 69, between the end plate of one twenty-five plate group and the first plate of the next twenty-five plate group. The number and organization of electrode plates in the electrode arrays 13, 15 may differ in different embodiments.

As shown in FIGS. 1 and 3, the first leg 18 of the first three plate group and the last leg 28 of the last of the three plate group are positioned, respectively between the two plates of the end plate pairs 17, 19; 23, 25. In an illustrative embodiment, the electrically coupled end plate pairs 17, 19; 23, 25 are nickel or titanium and the remaining plates are stainless steel, but could be formed of other suitable metals such as titanium in other embodiments. The number of plates and groupings thereof may also vary in various embodiments.

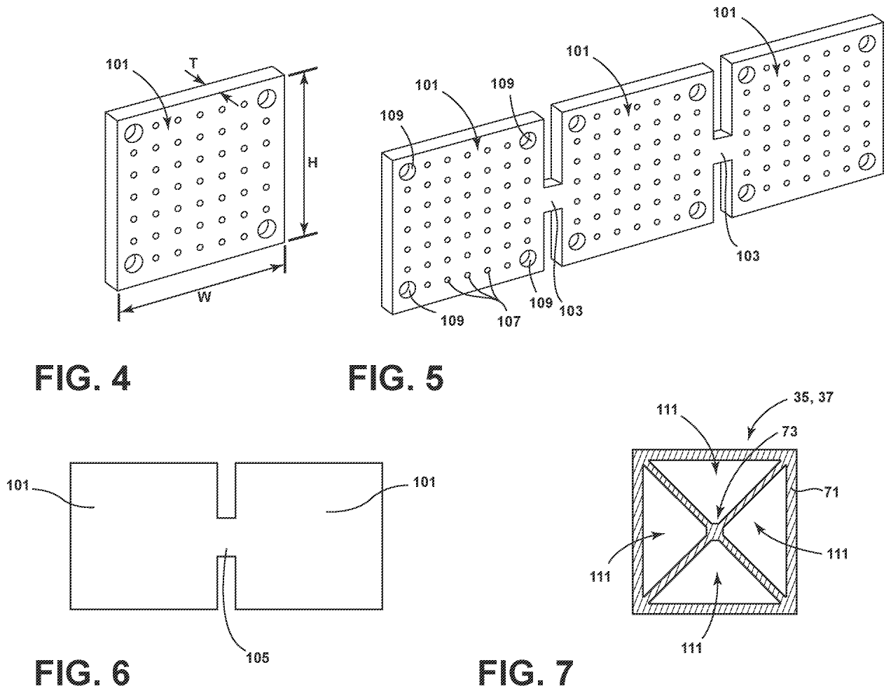

An illustrative electrode plate 101 is shown in FIG. 4. In an illustrative embodiment, the plate 101 has a width W and height H, each of which may be 4 inches, and may have a thickness T of 0.125 inches. The gap between each adjacent plate in FIG. 3 is also 0.125 inches in an illustrative embodiment. These dimensions of course can vary in various embodiments.

In the illustrative embodiment, each plate 101 further is perforated across its entire surface, for example, with ¼ inch diameter holes 107 spaced ¼ inch apart. Holes 109, for example, of ⅜-inch diameter are located at each corner of each plate 101 to accommodate nylon rods which pass through the holes 109 to hold the assembly together. These rods along with nylon spacers between each plate 101 hold the plate assembly together in an illustrative embodiment.

FIG. 5 illustrates three metal plates 101 connected together by 1 and ½ inch wide tabs 103, which allow the plates 101 to be bent and interconnected to form the three parallel plate groupings, as illustrated in FIG. 3. FIG. 6 similarly illustrates two metal plates 101 interconnected by a ½ inch wide tab 105, which allows the two plates 101 to be bent to form, for example, input plate pair 17, 19 and output plate pair 23, 25. In some embodiments, these plates 17, 19, 23, 25 may perforated in the same manner as the plates of FIG. 5.

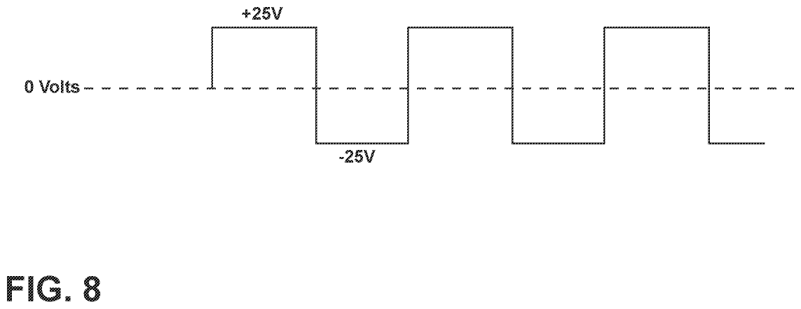

FIG. 7 illustrates the structure of an X-plate 35, 37, which, in the illustrative embodiment, may have the same outer dimensions and thickness as the plate 101. As shown, the X-plate has a rectangular frame 71 within which is formed and “X” shaped cross member 73. The triangular areas 111 between the frame 71 and cross member 73 are thus hollow and water transmissive. The X-plate shape results in less plate density and less surface area as opposed to a plate such as illustrated in FIG. 5 and hence limits the amount of current that can be drawn, thus facilitating low current operation.

In operation, the X plates 35, 37 serve as anodes providing a bias which causes electrons to flow through the plate stacks 13, 15. At start-up, the intense heat created by the plasma torches 38, 39 breaks the water apart into hydrogen and oxygen at the torch locations. Application of the pulsed 50-volt DC output of the first three phase rectifier 51 to the input and output plate pairs, e.g. 17, 19; 23, 25, provides an added electric field which is periodically created and then collapses, resulting in plasma electrolysis and generation of hydrogen gas throughout the plates located between each torch 38, 39 and its respective X plate 37, 35.

The cell of FIGS. 1-7 is high impedance/low current and is scalable to achieve various outputs of hydrogen gas. In this connection, embodiments may be configured to produce hydrogen at a rate of 30 kilograms per hour or more.

A second illustrative embodiment employs the same electrode plate arrangement shown in FIGS. 1 and 3 with the exception that the electrode plates are 22 inches wide by 24 inches high. The plates may again have a thickness T of 0.125 inches with each the plates of each of the arrays 13, 15 being equally spaced apart with the distance from one plate to the next being 0.125 inches. Again, these dimensions may vary in different embodiments.

In this second embodiment, the voltage out of the first three phase rectifier 51 applied across the input and output plate pairs is a plus (+) and minus (−) pulsed DC voltage as illustrated in FIG. 8. In the illustrative embodiment, the voltage waveform illustrated in FIG. 8 has a 50 per cent duty cycle at 180 Hz and a 50-volt amplitude range but may range in amplitude from 50 to 70 volts in various embodiments. In the illustrative second embodiment, the input voltage to the system from source 47 may range from 208 to 220 volts at 50 amps.

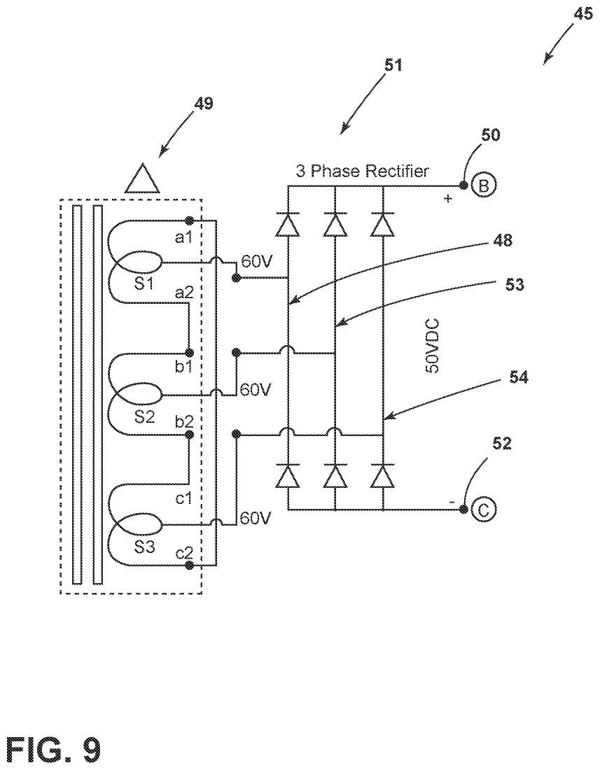

An alternate configuration of the secondary of the transformer 49 may also be employed, as shown in FIG. 9, where center taps of each of the secondary coils S1, S2, S3 are connected to the junctions of the respective diode pairs of the three-phase rectifier 51. In this embodiment, the voltage across each coil is 120 volts such that the center taps provide 60 volts each to the diode array of the first three-phase rectifier 51.

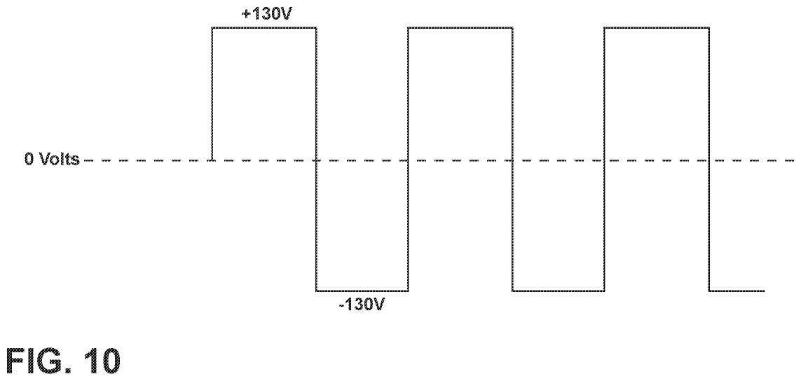

Also, in the second illustrative embodiment, the voltage out of the second three phase rectifier 53 applied across the plasma torches and X-plates is a plus (+) & minus (−) pulsed DC voltage as schematically shown in FIG. 10. In the illustrative embodiment, this waveform has a duty cycle of 50 per cent at 180 Hz and an amplitude range of 260 volts but may range in amplitude from 260 to 290 volts in various embodiments. The duty cycles of the two waveforms shown in FIGS. 8 and 10 may vary in other embodiments.

In such embodiments, the current to the plasma torches 38, 39 may range from 3 to 5 amps. In one embodiment, 15 kilowatts of input power may yield 30 kilograms of hydrogen (H2).

The sealed reaction vessel or “tank” 16 employed in the second embodiment may contain 120 gallons of deionized water solution comprising 1% potassium hydroxide at a temperature in the range of 120 to 160 degrees and under a pressure of six inches of mercury. In the second embodiment, the tank 16 may be constructed of polypropylene with a 14-gauge stainless steel frame constructed around the outside of the tank and may be 50 inches in length, 24 inches in width and 48 inches high.

In the second illustrative embodiment, the plate arrays, e.g., 13, 15, may be positioned two inches above the bottom of the tank 16, and the top of the arrays may lie one inch below the water level when the tank is filled to 120 gallons. A constant flow water system may be employed in various embodiments to maintain the water level in the tank as hydrogen is produced.

In illustrative embodiments, the oxygen in the output of the system may be separated from the hydrogen gas using a centrifugal process to produce hydrogen of 99 per cent purity, which may be further purified using, for example, a carbon nanotube membrane.

In various embodiments, hydrogen production may be further enhanced by employing mesh plates pressed course on one side of the plates and fine or less course on the opposite side where hydrogen gas forms. Nickel plates may particularly be formed in this fashion. Additionally, ultrasonic energy may be applied to vibrate the electrode plates to cause the hydrogen molecules to “fall off” the plates. Higher frequencies up to 10 MHz may also be used for such purpose.

In a third embodiment, the plate arrays may be connected in series and only one plasma torch 38 is employed, while the second plasma torch 39 is not used. In such case, the output voltage of the three-phase rectifier 53 is applied to the torch 38 and the two X-plates 35, 37, as in the first two embodiments. Terminal B of the first three-phase rectifier 51 is disconnected from the end plate pairs 23,25;31,33 and is instead connected to the input pair 27, 29. Terminal C of the three-phase rectifier 51 is disconnected from the output plate pair 27, 29. In this embodiment, the 120-volt voltage across each of the secondary transformer coils S1, S2, S3 is applied to the three-phase rectifier 51 as illustrated in FIG. 2.

Those skilled in the art will appreciate that various adaptations and modifications of the just described illustrative embodiments can be configured without departing from the scope and spirit of the invention. Therefore, it is to be understood that, within the scope of the appended claims, the invention may be practiced other than as specifically described herein.

What is claimed is:

1. An apparatus comprising:
a tank;
a hydrogen generating cell immersible in a liquid in the tank, the cell comprising an input electrode plate pair, an output electrode plate pair, an additional electrode plate positioned adjacent the output electrode plate pair, and a plurality of intermediate electrode plates disposed between the input and output electrode plate pairs;
a plasma torch spaced apart from and inductively coupled to the input electrode plate pair; and
driver circuitry comprising a transformer configured to be coupled to an output of an AC power source; a first three-phase rectifier coupled to an output of said transformer, a second three-phase rectifier configured to be coupled to said AC power source, the second three-phase rectifier being configured to apply a first voltage to the plasma torch and additional electrode plate, the transformer and first three-phase rectifier being configured to apply a second voltage to the input and output electrode plate pairs.

2. The apparatus of claim 1 wherein the additional electrode plate has a rectangular frame within which is formed an “X” shaped cross member and wherein a plurality of triangular areas between the frame and cross member are hollow and water transmissive,

3. The apparatus of claim 1 wherein the first voltage is a plus and minus pulsed DC voltage having a first amplitude range and the second voltage is a plus and minus pulsed DC voltage having a second amplitude range which is less than said first amplitude range.

4. The apparatus of claim 3 wherein the amplitude range of the first voltage is 260 volts and the amplitude range of the second voltage is 50 volts.

5. The apparatus of claim 1 wherein the plasma torch is a TIG plasma torch.

6. Hydrogen gas generating apparatus comprising:
a plurality of serially arranged electrode plates; and
a plasma torch spaced apart from and inductively couple to at least a first of said electrode plates.

7. The apparatus of claim 6 wherein the plurality of serially arranged electrode plates comprises an input electrode plate pair, an output electrode plate pair, and a plurality of intermediate electrode plates disposed between the input and output electrode plate pairs.

8. The apparatus of claim 6 wherein the plurality of serially arranged electrode plates and the plasma torch spaced apart from and inductively coupled to at least a first of the serially arranged electrode plates comprise part of a water immersible hydrogen generating cell.

9. The apparatus of claim 7 further comprising an additional electrode plate positioned adjacent and spaced apart from the output electrode plate pair on a side of the output plate electrode pair which is opposite a side of the output electrode plate pair which faces the intermediate electrode plates.

10. The apparatus of claim 9 wherein the additional electrode plate comprises a rectangular frame within which is formed an “X” shaped cross member and wherein triangular areas between the frame and cross member are hollow and water transmissive.

11. A method of constructing an apparatus for generating hydrogen comprising:
positioning a plurality of electrode plates serially adjacent and spaced apart from one another; and
positioning a plasma torch spaced apart from a first of said electrode plates so as to be inductively coupled to said first electrode plate.

12. The method of claim 11 further comprising configuring the plurality of electrode plates to comprise an input electrode plate pair, an output electrode plate pair, and a plurality of intermediate electrode plates disposed between the input and output electrode plate pairs.

13. The method of claim 12 further comprising constructing an additional electrode plate and positioning the additional electrode plate adjacent and spaced apart from the output electrode plate pair.

14. The method of claim 13 comprising constructing the additional electrode plate to comprise a rectangular frame within which is formed and “X” shaped cross member and wherein a plurality of triangular areas between the frame and cross member are hollow and water transmissive.

15. The method of claim 11 further comprising employing a TIG plasma torch as the plasma torch.

16. The apparatus of claim 9 wherein the plasma torch is a TIG plasma torch.

17. A hydrogen generating apparatus comprising:
first and second arrays of parallel electrode plates;
the first array including a pair of series connected input plates, a plate stack, and first and second series connected output plates;
the second array including a pair of series connected input plates, a plate stack, and first and second series connected output plates; and
first and second plasma torches, the first torch being inductively coupled to an input plate of the first array and the second torch being inductively coupled to an input plate of the second array.

18. The apparatus of claim 17 further comprising first and second additional electrode plates positioned between an outermost output plate of the first array and an outermost output plate of the second array.

19. The apparatus of claim 18 wherein each of the first and second additional electrode plates comprise a rectangular frame within which is formed and “X” shaped cross member and wherein respective triangular areas between the frame and cross member are hollow and water transmissive.

20. The apparatus of claim 17 wherein each of the first and second arrays of parallel electrode plates each comprise seventy-five adjacent parallel plates

21. The apparatus of claim 20 wherein the seventy-five adjacent parallel plates of each of the first and second arrays comprise three groups of twenty-five plates wherein the three groups are electrically isolated from one another except for an electrical connection between an end plate of the first group and a first plate of the second group and an electrical connection between an end plate of the second group and a first plate of the third group.

22. The apparatus of claim 17 wherein each of the plasma torches is a TIG plasma torch.

23. The apparatus of claim 1 wherein each of a plurality of the electrode plates is perforated across a plate surface thereof.

24. The apparatus of claim 1 wherein each of the electrode plates of the input electrode plate pair and output electrode plate pair comprises a nickel mesh pressed course on one side and less course on the opposite side.
